(19) United States
(12) Patent Application Publication
(10) Pub. No.: US 2013/0008280 A1
(43) Pub. Date: Jan. 10, 2013

(54) BRAKE HANDLE

(76) Inventor: Chia-Wei HSU, Taichung City (TW)

(21) Appl. No.: 13/177,248

(22) Filed: Jul. 6, 2011

(51) Int. Cl. G05G 1/04

(52) U.S. Cl. 74/522

(57) ABSTRACT

A brake handle of the present invention includes a handle member and an adjusting member. The handle member has a slide block, and the adjusting member has a slide chute corresponding to the slide block, so that the slide block can be movably received in the slide chute, wherein the slide block is disposed with an aperture, a bead and an elastic member. The aperture receives the bead and the elastic member therein. The slide chute is disposed with several notches. The bead elastically abuts against one of the notches when the slide block is received in the slide chute. Thereby, the adjusting member can be moved with respect to the handle member so as to change the length of the brake handle. As a result, a rider can rapidly adjust the brake handle with ease.

### BACKGROUND OF THE INVENTION

1. Field of the Invention

The present invention relates to a brake handle, and more particularly to a brake handle which can be adjusted for its length.

2. Description of the Prior Art

A conventional brake handle is used for a bike. The brake handle is disposed near the handle bar of the bike and is connected to the brake system. Thereby, riders can hold and grab the brake handle to pivot the brake handle and then brake the bike with the brake system.

However, said brake handle is often manufactured in one piece, so that the riders cannot adjust the length of said brake handle corresponding to the sizes of their hands. The riders having bigger hands cannot averagely apply force to said brake handle because the other part of their hands will easily fall out of said brake handle. In this situation, the riders will feel uncomfortable with their hands while riding.

Therefore, the present invention is arisen to obviate or at least mitigate the above mentioned disadvantages.

### SUMMARY OF THE INVENTION

The main object of the present invention is to provide an adjustable brake handle, so that the length of the brake handle can be adjusted by riders.

To achieve the above and other objects, a brake handle of the present invention includes a handle member and an adjusting member. One end of the handle member is disposed with a joint portion which is used for connecting to a bike.

One of the handle member and the adjusting member has a slide block, and the other one of the handle member and the adjusting member has a slide chute corresponding to the slide block. The slide chute is formed by at least one surface and has an opening toward the slide block. A width of the opening is smaller than the maximum width of the slide chute, so that the slide block is movably received in the slide chute. One of the slide block and the slide chute is disposed with an aperture, a bead and an elastic member. The aperture receives the bead and the elastic member therein. And the other one of the slide block and the slide chute is disposed with several notches. The bead elastically abuts against one of the notches when the slide block is received in the slide chute.

Thereby, the brake handle of the present invention can be adjustable according to the size of the rider's hands by moving the adjusting member. Further, riders only need to pull out or push in the adjusting member with hands so as to shift the adjusting member with respect to the handle member. Further, the bead can position the adjusting member, so there is no need for any other tools to adjust and fix the adjusting member.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is an exploded drawing showing a preferred embodiment of the present invention;

FIG. 2 is a stereogram showing a preferred embodiment of the present invention;

FIG. 2A is a partial sectional drawing showing a preferred embodiment of the present invention;

FIG. 3 is a perspective drawing showing a preferred embodiment of the present invention, wherein the adjusting member is close to the handle member;

FIG. 4 is a perspective drawing showing a preferred embodiment of the present invention, wherein the adjusting member is away from the handle member.

### DETAILED DESCRIPTION OF THE PREFERRED EMBODIMENTS

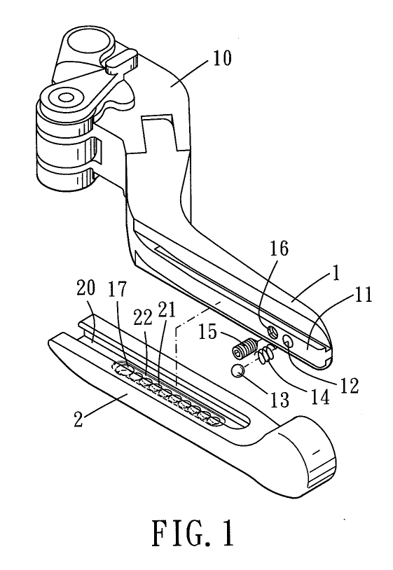

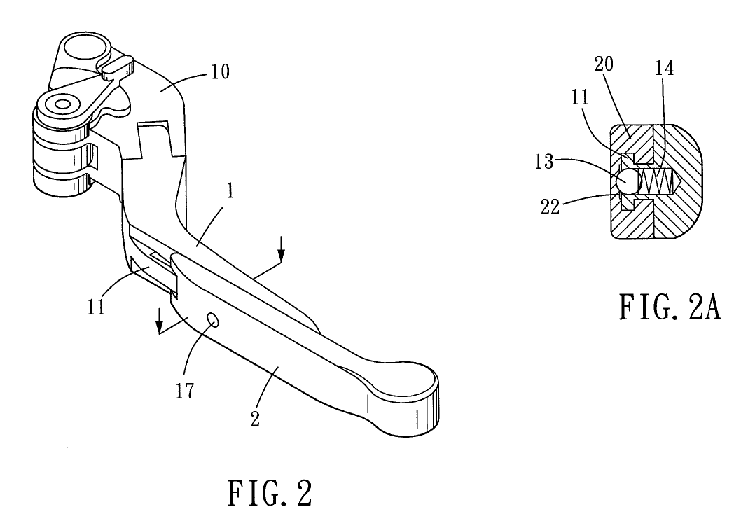

Please refer to FIG. 1, FIG. 2. The present invention provides a brake handle including a handle member 1 and an adjusting member 2. One end of the handle member 1 is disposed with a joint portion 10. The joint portion 10 is used for connecting to a bike. One end of the adjusting member which is away from the joint portion 10 is formed with a convex portion, as shown in FIG. 1. In other possible embodiments of the present invention, the end of the adjusting member 2 which is away from the joint portion 10 can be formed as a straight rod portion vertically extending therefrom.

In the present embodiment, the handle member 1 has a slide block 11, and the adjusting member 2 is formed with a slide chute 20 corresponding to the slide block 11. The slide chute 20 is formed by a bottom surface and several side surfaces, and the slide chute 20 further has an opening toward the slide block 11. A width of the opening is smaller than the maximum width of the slide chute 20, so that the slide block 11 is movably received in the slide chute 20. Consequently, the handle member 1 is joined with the adjusting member 2, as shown in FIG. 2. In other possible embodiments, the slide block can be formed as a convex shape, and the slide chute can be correspondingly formed by a concave arcuate surface. In addition, in other possible embodiments, the slide block 11 can be disposed on the adjusting member 2, and the slide chute 20 is oppositely disposed on the handle member 1.

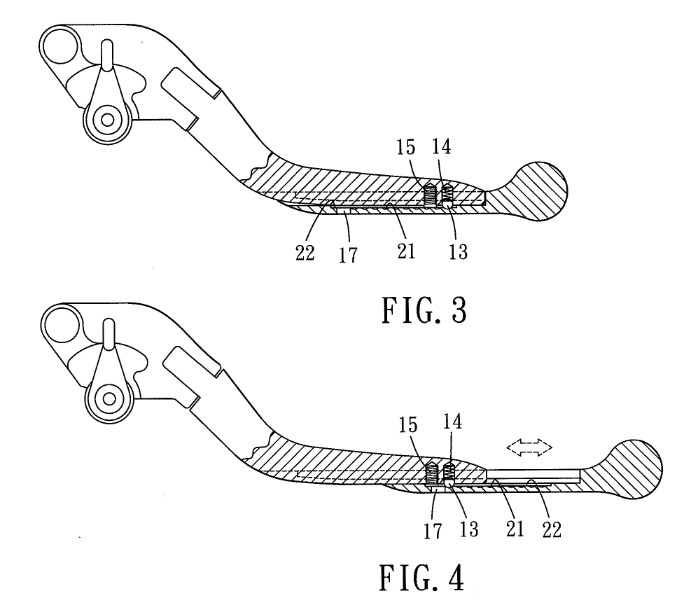

Please refer to FIGS. 1, 2A and 3. The slide block 11 is disposed with an aperture 12, a bead 13, and an elastic member 14. The aperture 12 receives the bead 13 and the elastic member 14 therein, and the bead 13 is on the top of the elastic member 14. Preferably, the aperture 12 is located on the slide block 11 and is close to one end of the handle member 1 which is away from the joint portion 10. More specifically, the location of the aperture 12 is near one end of the handle member 1, and the end is relatively away from the joint portion 10 compared to the other end thereof, as shown in FIG. 1. The slide chute 20 is disposed with several notches 21, and these notches 21 are located on the bottom surface. When the slide block 11 is received in the slide chute 20, the bead 13 supported by the elastic member 14 has a tendency to come off from the aperture 12, so that the bead elastically abuts against one of the notches 21, as shown in FIG. 2A. Thereby, the bead 13 can position the adjusting member 2 with respect to the handle member 1, as shown in FIG. 3. In other possible embodiments, the aperture 13, the bead 13 and the elastic member 14 can be disposed on the slide chute 20, and the slide block 11 is oppositely formed with the notches 21. Besides, in the other possible embodiment, the aperture 12 can be formed on the slide block or the slide chute which is disposed on the adjusting member 2. If the aperture is formed on the adjusting member, the aperture is near one end of the adjusting member, and the end is relatively close to the joint portion 10 compared to the other end thereof.

Please refer to FIG. 1 and FIG. 4. One of the slide block 11 and the slide chute 20 further comprises a limit member, and the other one of the slide block 11 and the slide chute 20 is formed with a groove 22 which communicates with the notches 21, wherein the limit member is adapted to abut against one end of the groove 22, and further to limit the movement of the slide block 11 with respect to the slide chute 20, and to prevent the slide block 11 from falling off from the slide chute 20. In the present embodiment, the limit member is a screw member 15, and the slide block 11 has a threaded hole 16. The screw member 15 is screwed into the threaded hole 16, and its screw head protrudes from the threaded hole 16. The groove 22 is located on the bottom surface of the slide chute 20, and the groove 22 communicates the notches 21 with the slide chute 20. When the slide block 11 is received in the slide chute 20, the screw head abuts against one end of the groove 22, and further limits the movement of the adjusting member 2 and prevents the adjusting member 2 from falling off from the slide block 11. Preferably, the limit member is located close to the aperture 12. In the present embodiment, the threaded hole 16 is near the aperture 12 and is closer to the joint portion 10 than the aperture 12. Thereby, when the adjusting member 2 is moved away from the handle member 1, the bead 13 can abut against one notch which is closest to the joint portion 10, and the screw member 15 which is fixed in the threaded hole 16 simultaneously abuts against one end of the groove 22 which is close to the joint portion 10, as shown in FIG. 4.

Moreover, please refer to FIG. 2 again. One of the slide block 11 and the slide chute 20 which is disposed with the groove 22 further comprises a through hole 17. In the present embodiment, the through hole 17 is disposed on the adjusting member 2, and the through hole 17 communicates the groove 22 with an external space. The through hole 17 is located near one end of the groove 22, and the end is close to the joint potion 10. When the adjusting member 2 is moved away from the handle member 1, the through hole 17 can communicate with the threaded hole 16, so that the screw member 15 can enter into the threaded hole 16 through the through hole 17.

Accordingly, in the present invention, the slide block 11 is connected to the slide chute 20, so that the adjusting member 2 can be joined to the handle member 1. Thereby, the adjusting member 2 can be moved close to or away from the handle member 1. In addition, the bead 13 can elastically abuts against one of the notches 21 and further position the adjusting member 2. The limit member can avoid the adjusting member falling off from the handle member.

To sum up, the brake handle of the present invention can provide riders to change its length without any tools. They can directly adjust the position of the adjusting member with respect to the handle member so as to change the length of the brake handle quickly.

What is claimed is:

1. A brake handle, comprising a handle member and an adjusting member, one end of the handle member being disposed with a joint portion, the joint portion being adapted to connect to a bike;
wherein one of the handle member and the adjusting member has a slide block, and the other one of the handle member and the adjusting member has a slide chute corresponding to the slide block, the slide chute is formed by at least one surface and has an opening toward the slide block, a width of the opening is smaller than a maximum width of the slide chute, so that the slide block is movably received in the slide chute;
wherein one of the slide block and the slide chute is disposed with an aperture, a bead and an elastic member, the aperture is adapted to receive the bead and the elastic member therein, the other one of the slide block and the slide chute is disposed with several notches, the bead elastically abuts against one of the notches when the slide block is received in the slide chute.

2. The brake handle of claim 1, wherein the aperture is disposed on the handle member, and the aperture is located near one end of the handle member which is away from the joint portion.

3. The brake handle of claim 1, wherein the aperture is disposed on the adjusting member, and the aperture is located near one end of the adjusting member which is close to the joint portion.

4. The brake handle of claim 1, wherein the one of the slide block and the slide chute which is disposed with the notches is formed with a groove, the groove communicates with the notches, the other one of the slide block and the slide chute which is disposed with the aperture is disposed with a limit member, the limit member is adapted to abut against one end of the groove so as to limit the movement of the slide block in the slide chute and prevent the slide block from coming off from the slide chute.

5. The brake handle of claim 4, wherein the limit member is a screw member, one of the slide block and the slide chute which is disposed with the aperture is disposed with a threaded hole, the screw member is screwed into the threaded hole, and one end of the screw member protrudes from the threaded hole.

6. The brake handle of claim 4, wherein the limited member is located near the aperture.

7. The brake handle of claim 5, wherein the one of the slide block and the slide chute which is disposed with the groove is disposed with a through hole, the through hole communicates the groove with an external space, the screw member enters into the threaded hole through the through hole when the slide block is received in the slide chute.

8. The brake handle of claim 7, wherein the through hole is located near one end of the groove.
